(19) United States
(12) Patent Application Publication
(10) Pub. No.: US 2026/0193054 A1
(43) Pub. Date: Jul. 9, 2026

(54) ELEVATOR SAFETY CONTROLLER, ELEVATOR SYSTEM, AND METHOD FOR CAUSING EMERGENCY STOP FOR ELEVATOR CAR

(71) Applicant: KONE Corporation, Helsinki (FI)

(72) Inventors: Asmo Tenhunen, Helsinki (FI); Juha-Matti Aitamurto, Helsinki (FI); Ari Kattainen, Helsinki (FI)

(73) Assignee: KONE Corporation, Helsinki (FI)

(21) Appl. No.: 19/558,902

(22) Filed: Mar. 6, 2026

Related U.S. Application Data
(63) Continuation of application No. PCT/EP2024/080404, filed on Oct. 28, 2024.

(30) Foreign Application Priority Data
Oct. 26, 2023 (EP) 23206100.2

(51) Int. Cl. B66B 5/04; B66B 1/30; B66B 1/32; B66B 1/36; B66B 5/02; B66B 9/00; B66B 13/22

(52) U.S. Cl. CPC B66B 5/04; B66B 1/30; B66B 1/32; B66B 1/36; B66B 5/027; B66B 9/00; B66B 13/22

(57) ABSTRACT

An elevator safety controller arranged for receiving status information from a plurality of elevator components of an elevator system is disclosed. The elevator safety controller is configured: to cause an immediate stop for an elevator car via operation of an elevator brake of the elevator system, if the received status information fulfills a first emergency stopping criteria; and to cause a velocity profile stop for an elevator car via operation of a motor drive unit of the elevator system, if the received status information fulfills a second emergency stopping criteria.

### FIELD OF THE INVENTION

The present invention relates in general to elevator systems. In particular, however not exclusively, the present invention concerns elevator safety systems and controllers utilizable in an elevator system and configured to cause an emergency stop in certain situations.

### BACKGROUND

Traditional elevators are provided with an elevator safety system. It may have plurality of components, such as landing door contacts and final limit switches connected in series with each other. Opening of a safety contact may usually indicate a safety risk, causing safety shutdown of the elevator, meaning that the use of the hoisting motor is prevented and motor brakes are engaged/activated.

This kind of solution is error-sensitive since a detected operational anomaly or a failure leads to immediate stopping of an elevator car. In case the elevator car then stops between landing floors, the elevator users will be left in the car until a service person arrives at elevator site to release the users. This may take some time and it may be inconvenient for the users or passengers trapped inside the car.

Patent document EP 4074641 A1 shows an elevator safety control device. It has two safety control channels, which are controlled by two microcontrollers. The safety control device has also an additional override processor, that monitors health of said two microprocessors. In case of a single-microcontroller failure, the additional processor overrides, i.e. takes control of, the safety control channel of the failed microcontroller, so that elevator operation can continue. The additional processor may increase overall system complexity and cost.

Patent document EP 4 095 081 A1 shows an elevator safety system. It has a controller that stops movement of the car in case a safety switch indicates potential hazard. The controller determines, if elevator car is located within an unlocking zone (e.g. door zone) and if this is the case it allows car door and landing door to be opened. This solution does not eliminate the problem posed for the users or passengers in case the car has stopped between the landing floors.

### SUMMARY

An objective of the present invention is to provide an elevator safety controller, an elevator system, and a method for causing an emergency stop for an elevator car. Another objective of the present invention is that the elevator safety controller, the elevator system, and the method allow continuing movement of elevator car in an emergency stopping situation to the next possible landing floor, such that users can be released from the car.

The objectives of the invention are reached by an elevator safety controller, an elevator system, and a method for causing an emergency stop for an elevator car as defined by the respective independent claims.

According to a first aspect, an elevator safety controller is provided. The elevator safety controller is arranged for receiving status information from a plurality of elevator components of an elevator system.

The elevator safety controller is configured to: cause an immediate stop for an elevator car via operation of an elevator brake of the elevator system, if the received status information fulfills a first emergency stopping criteria, and cause a velocity profile stop for an elevator car via operation of a motor drive unit of the elevator system, if the received status information fulfills a second emergency stopping criteria.

The elevator safety controller may be configured to cause the velocity profile stop as a default emergency stop. Thus, whenever any emergency stopping criterion is fulfilled, the velocity profile stop may be initiated. However, if it is detected that the first emergency stopping criterion being fulfilled is included of the first emergency stopping criteria, the elevator safety controller may be configured to cause the immediate stop right away.

The elevator safety controller may be configured to cause the immediate stop after initiating the velocity profile stop if, after the initiating, the first emergency stopping criteria is fulfilled.

The elevator safety controller may be configured to cause a motor drive unit of the elevator system to perform the velocity profile stop, preferably in a controlled manner. The velocity profile stop may be a constant deceleration stop or a constant braking torque stop. For example, the velocity profile stop may be or include as a portion thereof a decreasing speed ramp, optionally, with an adjustable or a pre-defined slope.

The immediate stop may be a maximum deceleration stop. The elevator safety controller may be configured to cause the elevator brake to perform the maximum deceleration stop.

In some embodiments, in addition to the elevator brake performing the immediate stop, such as the maximum deceleration stop, the motor drive unit may be set to simultaneously use Safe Torque Off (STO) functionality.

The elevator system may, thus, be configured to comprise a safety function (including the STO function) in connection with at least a number of solid-state switches of the motor drive unit, such as in a frequency converter or in an inverter. The safety function receives status information from a plurality of elevator components, such as safety contacts and/or safety switches. The safety function enables operation of the elevator car when the status information corresponds to the second emergency stopping criteria and prevents operation of the elevator when the status information corresponds to the first emergency stopping criteria. The second emergency stopping criteria may be determined, for example, when the status information indicates that all safety contacts/safety switches are closed, but there is still a need to provide a stop. The first emergency stopping criteria, in turn, may be determined in case the status information indicates that at least one of the safety contacts/switches is open. To disable elevator car operation, the safety function may be configured to block control signals of the associated solid-state switches. Correspondingly, to enable car operation, the safety function may be configured to allow control signals to reach the respective switches, such that a rotating field may be generated in the hoisting motor of a hoisting machinery of the elevator system.

The first emergency stopping criteria may comprise at least one of: the stop to be caused is a consequence of a time-critical failure, and the stop to be caused is a consequence of mechanically blocked failure.

The time-critical failure may relate to one of the following: unintended car movement protection situation, emergency terminal speed limiting situation, an overspeed situation of an ascending elevator car.

The mechanically blocked failure may be due to a foreign object, such as, in an elevator shaft of the elevator system, and/or at the elevator car or landing floor doors.

The mechanically blocked failure may be or relate to a foreign object. Alternatively, the mechanically blocked failure may be or relate to a buffer run, a stalling situation of an elevator car or a counterweight, or an operation of a safety gear. By using the immediate stop, such as a maximum deceleration stop, (e, g, by the elevator brake) in connection with these failures, compromising of the car top refuge space and a dangerous raising of the car or the counterweight may be avoided.

Term “buffer run” may refer to two different special situations. In a first situation, when the elevator hoisting motor drives the elevator car upwards, the elevator counterweight simultaneously moving downwards arrives at and presses against a safety buffer in the elevator shaft pit (the bottom of the elevator shaft). In a second alternative situation, when the hoisting motor drives the elevator car downwards, the elevator counterweight simultaneously moving upwards arrives at and presses and against a safety buffer in elevator shaft pit (the top of the elevator shaft).

The stalling situation refers herein to situations in which the weight of the elevator car and/or of the counterweight do not continuously maintain tension in the hoisting member(s) of the elevator system, i.e. hoisting rope(s) or belt(s). The tension in the hoisting member is crucial for having an adequate traction between the traction sheave and the hoisting member(s), and for ensuring that the hoisting member(s) remain taut at its/their intended routing. In the stalling situation, the tension is reduced, however, there may still be enough traction to move the elevator car or the counterweight.

For example, in the stalling situation one of the following occurs: the elevator car or the counterweight continues climbing upwards, e.g. due to high friction on the traction sheave, while the movement of the other one of the following the elevator car or the counterweight is stopped due to being stopped by safety gear, being stuck otherwise, or driving into end buffer(s).

In an embodiment, the elevator safety controller may be configured to cause a motor drive unit of the elevator system to perform the velocity profile stop, preferably in a controlled manner. The velocity profile stop may be a constant deceleration stop or a constant braking torque stop. For example, the velocity profile stop may be or include as a portion thereof a decreasing speed ramp, optionally, with an adjustable or a pre-defined slope. Then, during the velocity profile stop, that is after its initiation but before completion thereof, a stalling situation is detected, for example, by a motor drive unit (due to a change in torque requirement of a hoisting motor of the elevator system indicative of the stalling situation) or by a stalling detector in connection with a hoisting rope or a second rope arrangement, such as a rescue rope arrangement, a stalling detection rope arrangement, or a compensation rope arrangement, or a combination of the mentioned second rope arrangement examples. The stalling detector may, preferably, be configured to monitor tension in the rope(s). The elevator safety controller may be configured to cause the immediate stop in response to the detection of the stalling situation.

The second emergency stopping criteria may comprise: the stop to be caused is a consequence of a single-channel failure of at least one of the elevator components, or a consequence of a person operating an inspection operating button or buttons, an emergency electrical operation button or buttons, or stopping device or devices. Preferably, the at least one of the elevator components, in that case, comprises a, preferably duplicated, two-channel structure, or more-than-two-channel structure.

The safety controller may be arranged to receive status information from a motor drive unit of the elevator system about determination/identification of the mechanically blocked failure based on a criterion related to a predetermined change in torque requirement of a hoisting motor of the elevator system. For example, a stalling situation, as an example of the mechanically blocked failure, may be determined, when a torque reference, or a change thereof, of the motor drive unit reaches a predetermined torque (change) threshold value, thereby indicating that the movement of the elevator car and/or the counterweight has become more difficult due to the stalling situation. Similarly, a buffer run or an operation of a safety gear may be determined based on the predetermined change in torque requirement of a hoisting motor of the elevator system.

The first emergency stopping criteria may have a higher priority than the second emergency stopping criteria, such that upon causing the immediate stop it will remain valid until an elevator car has stopped, and it can only be reset after stopping of the elevator car.

The second emergency stopping criteria may comprise: the stop to be caused is a consequence of an overspeed situation of an elevator car located in a middle of an elevator shaft of the elevator system.

The second emergency stopping criteria may comprise: the stop to be caused is a consequence of a landing door contact opening at a long distance away from the elevator car. Preferably, the long distance is at least such that the elevator car is estimated to be stopped before reaching the landing with the landing door contact opening.

Furthermore, the elevator safety controller may be configured to cause the velocity profile stop to move the elevator car to a landing floor, such as to the closest landing floor relative to the current position thereof.

The elevator safety controller may be configured to cause the immediate stop to be performed via operation of the elevator brake(s) during the velocity profile stop, that is after the velocity profile stop has been initiated, if the received status information fulfills the first emergency stopping criteria, optionally including the car speed exceeding reference speed more than allowed.

The first emergency stopping criteria and the second emergency stopping criteria may, preferably, be mutually exclusive criteria. For example, if the first emergency stopping criteria are fulfilled or satisfied, the second emergency stopping criteria cannot be fulfilled or satisfied at the same time, and vice versa.

The elevator safety controller may be configured to cause an immediate stop via operation of the elevator brake, if the received status information fulfills an overspeed situation during the velocity profile stop.

The elevator safety controller may be a separate device being configured to receive and sent data and/or control commands outside thereof to other elevator devices. Alternatively, the elevator safety controller may be partly or completely integrated into the elevator control unit or the motor drive unit.

According to a second aspect, an elevator system is provided. The elevator system comprises an elevator car for transferring users and/or cargo between landing floors, a hoisting motor configured to move the elevator car, a motor drive unit configured to drive the hoisting motor, an elevator brake, a plurality of elevator components, and a safety controller in accordance with the first aspect or any embodiment thereof.

Furthermore, the elevator system may comprise diagnostic means for diagnosing operating condition of landing door system. Optionally, the elevator safety controller is then configured to cause a velocity profile stop of an elevator car to the next possible floor with an intact landing door, that is, based on information provided by the diagnostic means with respect to landing floor doors.

In various embodiments, at least one of the elevator components may have a functionally duplicated two-channel structure, or a structure with even more than two channels.

The plurality of elevator components may comprise at least one of or are selected from the group consisting of: an elevator safety device, such as a camera, a position sensor, a landing door contact, a car door contact, or a final limit switch.

The elevator component may, alternatively or in addition to the list above, an elevator control unit or a component of a control unit, such as a processor.

The elevator safety controller may be at least communicatively connected to the plurality of elevator components.

The elevator system may comprise a stalling detector. The stalling detector may be arranged in connection with an elevator car, a counterweight, a pulley, or a roping arrangement, such as the hoisting rope or a second rope arrangement.

According to a third aspect, a method for causing an emergency stop for an elevator car is provided. The method comprises receiving, by an elevator safety controller, status information from a plurality of elevator components of an elevator system, and selectively causing an immediate stop or a velocity profile stop for an elevator car. The immediate stop is performed via operation of an elevator brake of the elevator system, if the received status information fulfills a first emergency stopping criteria, and the velocity profile stop is performed via operation of a motor drive unit of the elevator system, if the received status information fulfills a second emergency stopping criteria.

The method may further comprise causing the immediate stop to be performed via operation of the elevator brake(s) during the velocity profile stop, that is after the velocity profile stop has been initiated, if the received status information fulfills the first emergency stopping criteria, optionally including the car speed exceeding reference speed more than allowed.

The present invention provides an elevator safety controller, an elevator system, and a method for causing an emergency stop for an elevator car. The present invention provides advantages over known solutions in that entrapment of users is avoided. The solution allows extending movement of elevator car in an emergency stopping situation to the next possible landing floor, such that users or passengers can be released from the car, without compromising elevator safety.

Various other advantages will become clear to a skilled person based on the following detailed description.

The expression “a number of” may herein refer to any positive integer starting from one (1).

The expression “a plurality of” may refer to any positive integer starting from two (2), respectively.

The terms “first”, “second” etc. are herein used to distinguish one element from another element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in the appended patent claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 illustrates schematically an elevator safety controller.

FIG. 2 illustrates schematically an elevator system.

FIG. 3 shows a flow diagram of a method.

FIG. 4 shows a speed-time graph illustrating characteristics of an example case of a velocity profile stop.

FIGS. 5A and 5B illustrate an example of an elevator system comprising a stalling detector configured to detect an increase/decrease in tension of a second rope arrangement.

FIGS. 6A and 6B illustrate another example of an elevator system comprising a stalling detector configured to detect an increase/decrease in tension of a second rope arrangement.

### DETAILED DESCRIPTION OF SOME EMBODIMENTS

An elevator safety controller, in accordance with various embodiments, may be arranged for receiving status information from a plurality of elevator components of an elevator system 200. The elevator safety controller 10 may be configured to cause an immediate stop for an elevator car via operation of an elevator brake of the elevator system, if the received status information fulfills a first emergency stopping criteria, and cause a velocity profile stop for an elevator car via operation of a motor drive unit of the elevator system, if the received status information fulfills a second emergency stopping criteria.

The first emergency stopping criteria may comprise at least one of: the stop to be caused is a consequence of a time-critical failure, and the stop to be caused is a consequence of a mechanically blocked failure.

The elevator safety controller may be configured to cause the velocity profile stop as a default emergency stop. Thus, whenever any emergency stopping criterion is fulfilled, the velocity profile stop may be initiated. However, if it is detected that the first emergency stopping criterion being fulfilled is included of the first emergency stopping criteria, the elevator safety controller may be configured to cause the immediate stop right away.

The elevator safety controller may be configured to cause the immediate stop after initiating the velocity profile stop if, after the initiating, the first emergency stopping criteria is fulfilled.

The elevator safety controller may be configured to cause a motor drive unit of the elevator system to perform the velocity profile stop, preferably in a controlled manner. The velocity profile stop may be a constant deceleration stop or a constant braking torque stop. For example, the velocity profile stop may be or include as a portion thereof a decreasing speed ramp, optionally, with an adjustable or a pre-defined slope.

The immediate stop may be a maximum deceleration stop. The elevator safety controller may be configured to cause the elevator brake to perform the maximum deceleration stop.

The time-critical failure relates to one of the following: unintended car movement protection (UCMP) situation, emergency terminal speed limiting (ETSL) situation.

The mechanically blocked failure may be a foreign object.

The safety controller may be arranged to receive status information from a motor drive unit of the elevator system about determination/identification of the mechanically blocked failure based on a criteria related to predetermined change in torque requirement of a hoisting motor of the elevator system.

The first emergency stopping criteria may have a higher priority than the second emergency stopping criteria, such that upon causing the immediate stop it will remain valid until an elevator car has stopped, and it can only be reset after stopping of the elevator car.

The second emergency stopping criteria may comprise: the stop to be caused is a consequence of a single-channel failure of at least one of the elevator components. Preferably, the at least one of the elevator components, in that case, may comprise a, preferably duplicated, two-channel structure, or more-than-two-channel structure.

The second emergency stopping criteria may comprise: the stop to be caused is a consequence of an overspeed situation of an elevator car located in a middle of an elevator shaft of the elevator system.

Alternatively or in addition, the second emergency stopping criteria may comprise: the stop to be caused is a consequence of a landing door contact opening at a long distance away from the elevator car. The long distance may be such that the elevator car is estimated to be stopped before reaching the landing with the landing door contact opening.

Furthermore, the elevator safety controller may be configured to cause the velocity profile stop to move the elevator car to a landing floor.

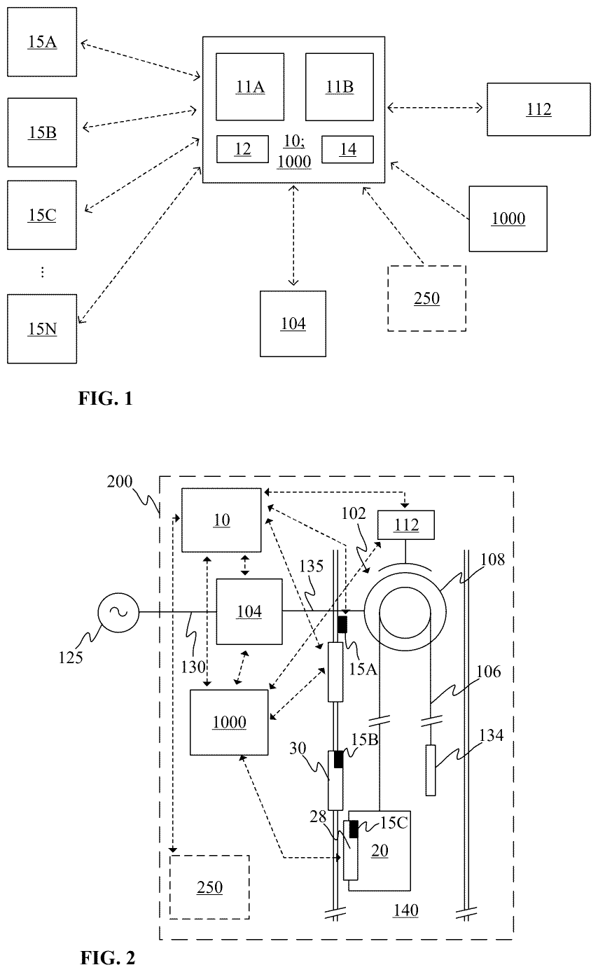

FIG. 1 illustrates schematically an elevator safety controller 10. The elevator safety controller 10 is arranged for receiving status information from a plurality of elevator components 15A-15N of an elevator system. The elevator safety controller 10 is configured to cause an immediate stop for an elevator car via operation of an elevator brake of the elevator system, if the received status information fulfills a first emergency stopping criteria; and to cause a velocity profile stop for an elevator car via operation of a motor drive unit of the elevator system, if the received status information fulfills a second emergency stopping criteria.

The plurality of elevator components 15A-15N may comprise at least one of or are selected from the group consisting of: an elevator safety device, such as a camera, a position sensor, a landing door contact, a car door contact, or a final limit switch.

In various embodiments, the plurality of elevator components 15A-15N are, preferably, safety critical devices which control and/or monitor safety of the elevator system.

Furthermore, in various embodiments, the elevator safety controller 10 may also be itself included in the plurality of elevator components 15A-15N. For example, the elevator safety controller 10 may exhibit a two-channel structure, such that a single-channel failure of the component will not render the component inoperative. The elevator safety controller 10 may thus still be arranged for receiving status information from a plurality of other elevator components of an elevator system 200, and be configured to cause the immediate stop for an elevator car via operation of an elevator brake of the elevator system, if the received status information fulfills a first emergency stopping criteria, and cause the velocity profile stop for an elevator car via operation of a motor drive unit of the elevator system, if the received status information fulfills a second emergency stopping criteria.

Alternatively or in addition, the plurality of elevator components 15A-15N may be related to elevator safety chain. The elevator safety chain may be, for example, such that it comprises a safety sensor or switch at each of the relevant safety elevator components 15A-15N, and all safety sensors or switches are connected, at least functionally, in series, controlling a safety controller, such as including a safety relay. When all the safety sensor or switches in the normal operation state, the elevator operates in normal manner. If even one of them changes its state to abnormal operation state, the elevator will stop or at least change away from the normal operation state.

Furthermore, the elevator safety controller 10 may comprise one or two, or even more than two, processing units 11A, 11B. Thus, there can be a redundant, two-channel structure, such that a single-channel failure of the component will not render the component inoperative.

Furthermore, the elevator safety controller 10 may comprise memory device(s) 12. Furthermore, the elevator safety controller 10 may comprise other sub-units or components, such as related to communication and/or controlling/adjusting of its operation.

FIG. 1 also shows that the elevator safety controller 10 may be suitable for connecting, at least communicatively, to an elevator brake arrangement 112 comprising an elevator brake, and to an elevator motor drive unit 104 which may be arranged to operate a hoisting motor for moving an elevator car.

Still further, the elevator safety controller 10 may be suitable for connecting, at least communicatively, to an elevator control unit 1000 for controlling the operation of the elevator system, and/or to other systems/devices, such as diagnostic means for diagnosing operating condition of landing door system 250.

FIG. 2 illustrates schematically an elevator system 200 which may comprise an elevator safety system 200 as described hereinabove. The elevator system 200 may comprise an elevator motor drive unit 104, such as including an electric converter. The elevator system 200 may comprise an elevator, or “hoisting”, motor 102, such as a permanent magnet electric motor, for moving an elevator car 20 comprised in the elevator system 100. The hoisting motor 102 may be arranged to rotate a traction sheave 108. The elevator car 20 may be mechanically coupled to the hoisting motor 102, preferably, by a hoisting rope 106, for example, extending via the traction sheave 108. The operation of the hoisting motor 102 may be controlled by the elevator motor drive unit 104, such as including a frequency converter or an inverter. The elevator car 20 may be moved in and/or along an elevator shaft 140. The elevator car 20 may be moved in a normal operation mode to serve landings or landing floors in accordance with elevator calls. Also shown are the elevator car doors 28 and the landing floor doors 30.

FIG. 2 also shows, marked with black boxes, some of the plurality of elevator components 15A-15N which may or may not be utilized in an elevator system 200 in accordance with an embodiment.

In various embodiments, the elevator car 20 is adapted for transferring users, or passengers, and/or cargo between landing floors at least during normal operation of the system 200.

The hoisting rope 106 may comprise, for example, steel or carbon fibers. The term ‘hoisting rope’ does not limit the form of the rope anyhow. For example, the hoisting rope 106 may be implemented as a rope or a belt.

The hoisting motor 102 may be arranged in mechanical coupling with a traction sheave 108. Furthermore, the hoisting rope 106 may be arranged to run via the traction sheave 108 for the hoisting motor 102 to be able to move the elevator car 20 coupled to the hoisting rope 102. Still further, being connected to the hoisting rope 102, may preferably be a counterweight 114 for the elevator car 20. Although shown in FIG. 2 that the hoisting rope 106 would be attached from one end to the elevator car 20 and from the opposite end to the counterweight 114, and then simply running via the traction sheave 108, in practice, the hoisting rope 106 may run via one or several other sheaves and components, and may be terminated at the hoisting rope terminals, as known to a skilled person in the art. Thus, depending how the hoisting rope 106 is arranged to run, for example, past how many sheaves and how such configuration is designed and arranged, the roping ratio may be different from one elevator system 200 to another.

The elevator system 200 may comprise an elevator control unit 1000 for controlling the operation of the elevator system 200, such as various devices thereof. The elevator control unit 1000 may be a separate device or may be comprised in the other components of the elevator system 200 such as in or as a part of the elevator motor drive unit 104. In various embodiments, the elevator control unit 1000 comprises the elevator motor drive unit 104.

In some embodiments, the elevator control unit 1000 may comprise the elevator motor drive unit 104, however, in other embodiments, they may be separate entities, in which case the elevator control unit 1000 may be in communication connection with the elevator motor drive unit 104, such as providing input signal/data thereto and/or therefrom.

The elevator control unit 1000 may also be implemented in a distributed manner so that, e.g., one portion of the elevator control unit 1000 may be comprised in the elevator motor drive unit 104 and another portion in the elevator car 20, for instance. The elevator control unit 1000 may also be arranged in distributed manner at more than two locations or in more than two devices. The elevator control unit 1000 may be arranged to at least communicate (examples of such connections being shown with dashed two-headed arrows) with various devices of the elevator system 200.

The elevator system 200 may further comprise an elevator brake arrangement 112 comprising an elevator brake, preferably, an electromechanical elevator brake.

There may be also a main electrical power supply 125 such as a three-phase or single-phase electrical power grid, an electrical connection 130 between the power supply 125 and the elevator motor drive unit 104, another electrical connection 135 between the elevator motor drive unit 104 and the hoisting motor 102.

The elevator system 200, or particularly the elevator motor drive unit 104 of the elevator system 200, may be configured to detect a stalling situation. The detection may be based on a change in torque requirement of the hoisting motor 102 of the elevator system 200, the change being indicative of the stalling situation.

In an embodiment, the elevator safety controller 10 may be configured to cause a motor drive unit 104 of the elevator system 200 to perform the velocity profile stop, preferably in a controlled manner. The velocity profile stop may be a constant deceleration stop or a constant braking torque stop. For example, the velocity profile stop may be or include as a portion thereof a decreasing speed ramp, optionally, with an adjustable or a pre-defined slope. Then, during the velocity profile stop, that is after its initiation but before completion thereof, a stalling situation is detected, for example, by a motor drive unit 104 (due to a change in torque requirement of a hoisting motor 102 of the elevator system 200 indicative of the stalling situation) or by a stalling detector in connection with a hoisting rope or a second rope arrangement, such as a rescue rope arrangement, a stalling detection rope arrangement, or a compensation rope arrangement, or a combination of the mentioned second rope arrangement examples. The stalling detector may, preferably, be configured to monitor tension in the rope(s). The elevator safety controller may be configured to cause the immediate stop in response to the detection of the stalling situation.

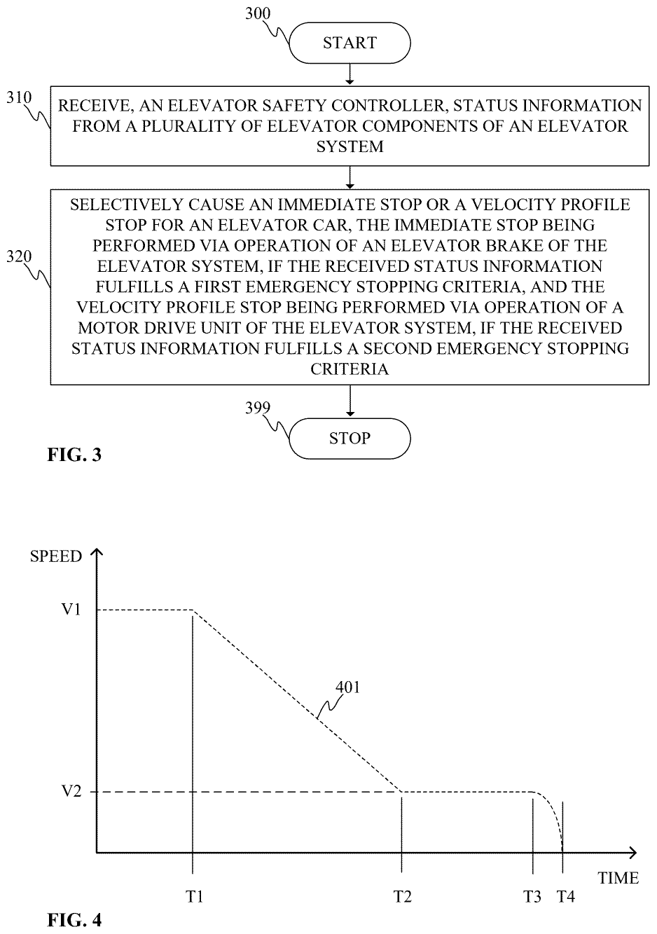

FIG. 3 shows a flow diagram of a method. In various embodiments, the method is for continuing operation of an elevator system after a malfunction or failure. The method steps may, in accordance with a non-limiting example, be performed by the elevator safety controller 10. Furthermore, the features of the elevator safety controller 10, namely the functionality thereof, as described in this document, may be considered also as method steps that may be performed in the method as described herein.

Item or step 300 refers to a start-up phase of the method. Suitable equipment and components are obtained, and systems assembled and configured for operation.

Item or step 310 refers to receiving, an elevator safety controller, status information from a plurality of elevator components of an elevator system 200.

Item or step 320 refers to selectively causing an immediate stop or a velocity profile stop for an elevator car, wherein, regarding the selectively causing, the immediate stop is performed via operation of an elevator brake of the elevator system, if the received status information fulfills a first emergency stopping criteria, and the velocity profile stop is performed via operation of a motor drive unit of the elevator system, if the received status information fulfills a second emergency stopping criteria.

Method execution may be stopped at item or step 399.

The first emergency stopping criteria may comprise at least one of: the stop to be caused is a consequence of a time-critical failure, and the stop to be caused is a consequence of a mechanically blocked failure.

The time-critical failure relates to one of the following: unintended car movement protection (UCMP) situation, emergency terminal speed limiting (ETSL) situation.

The mechanically blocked failure may be a foreign object.

The second emergency stopping criteria may comprise: the stop to be caused is a consequence of a single-channel failure of at least one of the elevator components 15A-15N. Preferably, the at least one of the elevator components 15A-15N, in that case, may comprise a, preferably duplicated, two-channel structure, or more-than-two-channel structure.

The second emergency stopping criteria may comprise: the stop to be caused is a consequence of an overspeed situation of an elevator car 20 located in a middle of an elevator shaft 140 of the elevator system 200.

Alternatively or in addition, the second emergency stopping criteria may comprise: the stop to be caused is a consequence of a landing door contact opening at a long distance away from the elevator car 20. The long distance may be such that the elevator car 20 is estimated to be stopped before reaching the landing with the landing door contact opening.

Furthermore, the method may comprise causing the velocity profile stop to move the elevator car 20 to a landing floor.

FIG. 4 shows a speed-time graph 510 illustrating characteristics of an example case of a velocity profile stop. Speed of an elevator car and/or a hoisting motor is on the vertical axis and time is on the horizontal axis.

In FIG. 4, the elevator car 20 is being moved prior to time instance T1 in accordance with principles of normal operation. Thus, in FIG. 4, abnormal or emergency conditions, such as due to operational anomaly, failure or malfunction, occur and/or are detected at time instance T1. The elevator safety controller 10 receives status information from one (or more) of the plurality of elevator components 15A-15N indicating the emergency condition. Prior to that, the elevator car 20 was, in this example case, being moved with a constant speed of the normal operating conditions, such as in the range of 0.7-10, preferably 1-5 meters per second, such as 1.2 or 1.5 meters per second or the like.

In this example case, the received status information fulfills the second emergency stopping criteria. For example, the stop to be caused may be a consequence of a single-channel failure of at least one of the elevator components, such as of the elevator safety controller 10 itself or other of the plurality of elevator components 15A-15N. According to another example, the stop to be caused may be a consequence of an overspeed situation of an elevator car 20 located in a middle of an elevator shaft 140. Still according to another embodiment, the stop to be caused may be a consequence of a landing door contact opening at a long distance away from the elevator car 20. Preferably, the long distance is at least such that the elevator car is estimated to be stopped before reaching the landing with the landing door contact opening.

Notwithstanding which criterion is one of the second emergency stopping criteria is fulfilled or satisfied, at time instance T1 in FIG. 4, the elevator safety controller 10 causes the velocity profile stop for an elevator car 20 via operation of the motor drive unit 104 of the elevator system 200. This is shown to happen starting at or right after time instance T1 or ending at time instance T4 when the elevator car 20 stops completely.

As can be seen in the non-limiting example of FIG. 4, the speed of the elevator car 20 first decreases gradually between time instances T1 and T2. The final speed at T2 may be, for example, in the range of 0.20 to 1.00 meters per second, such as about 0.30 or 0.63 meters per second or the like, however, could be something else too. In general, this constant portion of the velocity profile stop prior to the full stop may be less than one third of the nominal speed of the elevator car 20.

Finally, as a non-limiting example, final deceleration phase is started at time instance T3 and it ends at T4.

In various embodiments, the elevator car 20 is stopped at a landing floor at time instance T4. Thus, for example, once the speed has been reduced to the speed of said constant portion of the velocity profile stop, the elevator car 20 may be moved with this lower than nominal speed until the destination landing floor is reached and the final deceleration phase is performed to arrive at the landing. Then, when the car 20 has been essentially stopped, the elevator brake(s) are applied and the users/passengers are released from the car 20.

As can be understood by the skilled person, the graph 401 of related to the velocity profile stop may take various different shapes and/or may persist for different time periods depending on the situation and/or the elevator system 200 in question.

In some embodiments, the velocity profile stop may include an initial deceleration phase right after the elevator safety controller 10 initiates the velocity profile stop for an elevator car 20. Optionally, there may also be a portion of lower than nominal speed, such as having a constant speed (such as shown in FIG. 4 between time instances T2 and T3) or slowly decreasing speed portion. This portion may be used to approach the destination or the currently closest landing at lower than nominal speed. Furthermore, in some cases, the velocity profile stop may include the final deceleration phase (such as between T3 and T4), although, it can also be part of the initial deceleration phase or the slowly decreasing speed portion. It is also possible that motor brakes are triggered at time instance T3, and the car stops at time instance T4 by means of the applied motor brakes.

Furthermore, regarding the operation of the elevator system 200, in normal operation, elevator motor drive unit 104, preferably, calculates velocity reference for elevator car trip from departure floor to the destination floor.

In the velocity profile stop, which takes place in an operational anomaly, there are many possibilities. One possibility is, that the elevator safety controller 10 provides a velocity profile stop triggering command to the elevator motor drive unit 104, which then either calculates a velocity reference ramp or uses a pre-stored velocity profile with the velocity reference ramp, such that the elevator car 20 includes a (constant) deceleration portion during the velocity reference ramp.

Alternatively, the elevator safety controller 10 may generate the velocity reference ramp, and then provide it to the elevator motor drive unit 104. The elevator motor drive unit 104 then controls car speed such that it follows the velocity ramp in accordance with the velocity reference ramp.

In some embodiments, during the stopping procedure, elevator motor drive unit 104 operates under control of the elevator safety controller 10, such that safety controller 10 monitors car speed during the velocity profile stop and, if the car speed exceeds reference speed more than allowed, the safety controller 10 generates an immediate stopping command of the car, causing an immediate stop by interrupting motor power and applying the motor brakes.

Thus, the elevator safety controller 10 may be configured to cause the immediate stop to be performed via operation of the elevator brake(s) during the velocity profile stop, if the received status information fulfills the first emergency stopping criteria, including an overspeed situation wherein the car speed exceeds reference speed more than allowed.

The elevator safety controller 10 may, preferably, be arranged to received elevator car speed information from a speed or position sensors in the shaft 120 or from the motor 102.

In an embodiment, the elevator safety controller 10 may be arranged to receive status information from the motor drive unit 104 of the elevator system 200 about determination/identification of the mechanically blocked failure based on a criterion related to a predetermined change in torque requirement of a hoisting motor of the elevator system. For example, a stalling situation, as an example of the mechanically blocked failure, may be determined, when a torque reference, or a change thereof, of the motor drive unit 104 reaches a predetermined torque (change) threshold value, thereby indicating that the movement of the elevator car and/or the counterweight has become more difficult due to the stalling situation.

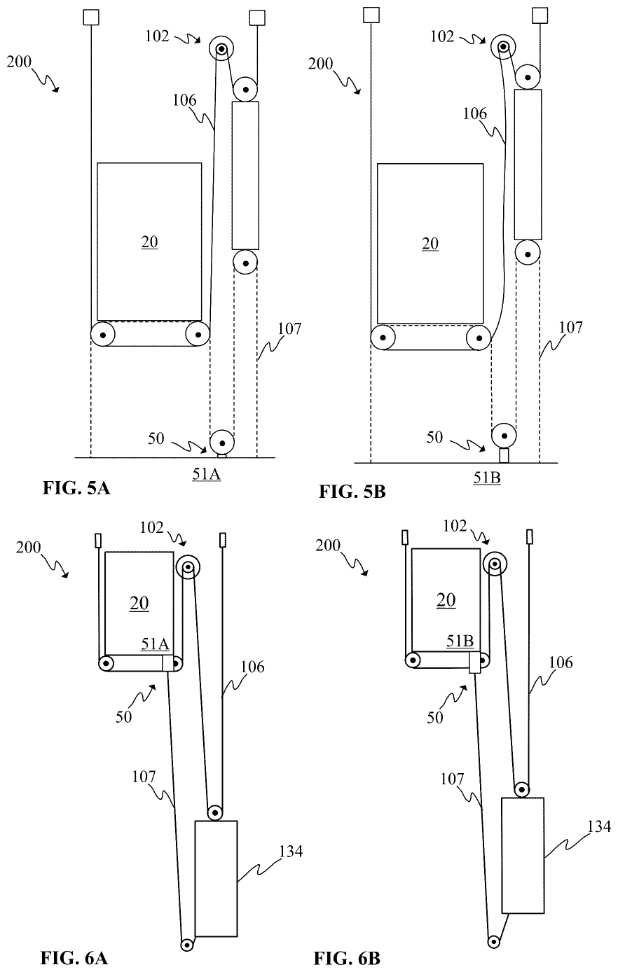

FIGS. 5A and 5B illustrate an example of an elevator system 200 comprising a stalling detector 50 configured to detect an increase/decrease in tension of a second rope arrangement 107. The stalling detector 50 may be configured to have a normal state 51A in which the tension is in an acceptable range. Furthermore, the stalling detector 50 may be configured to have a stalling detection state 51B in which the tension is outside the acceptable range due to the tension being too high or too low. In FIGS. 5A and 5B, the stalling detector 50 is arranged in connection with a pulley via which the second rope arrangement 107 extends.

FIGS. 6A and 6B illustrate another example of an elevator system comprising a stalling detector 50 configured to detect an increase/decrease in tension of a second rope arrangement 107. The stalling detector 50 may be configured to have a normal state 51A in which the tension is in an acceptable range. Furthermore, the stalling detector 50 may be configured to have a stalling detection state 51B in which the tension is outside the acceptable range due to the tension being too high or too low. In FIGS. 6A and 6B, the stalling detector 50 is arranged in connection with the elevator car.

Thus, the elevator system 200, or specifically the elevator safety controller 10, may be configured to detect the stalling situation by a stalling detector 50 in connection with a hoisting rope 106 or a second rope arrangement 107, such as a rescue rope arrangement, a stalling detection rope arrangement, or a compensation rope arrangement, or a combination of the mentioned second rope arrangement examples. The stalling detector 50 may, preferably, be configured to monitor tension in the rope(s). The elevator safety controller 10 may be configured to cause the immediate stop in response to the detection of the stalling situation.

The operation of the stalling detector 50 may be based on elongation and/or compression of a tension element, such as a spring element. The stalling detector 50 may also comprise one or more sensors for detecting the elongation and/or compression of the tension element.

In an embodiment, the elevator safety controller 10 may be arranged to receive status information from the stalling detector 50 about determination/identification of the mechanically blocked failure, especially of the stalling situation.

It is also noted herein that while the above describes example embodiments, these should not be viewed in a limiting sense. Rather, there are several variations and modifications, which may be made without departing from the scope of the present disclosure as defined in the appended claims.

The previously presented considerations concerning the various embodiments of the device may be flexibly applied to the embodiments of the method, and vice versa, as being appreciated by a skilled person.

Some advantageous embodiments of the elevator safety controller, the elevator system, and the method according to the invention have been described above. The invention is not limited to the embodiments described above, but the inventive idea can be applied in numerous ways within the scope of the claims. The features recited in dependent claims are mutually freely combinable unless otherwise explicitly stated.

1. An elevator safety controller arranged for receiving status information from a plurality of elevator components of an elevator system, the elevator safety controller being configured to:
cause an immediate stop for an elevator car via operation of an elevator brake of the elevator system, if the received status information fulfills a first emergency stopping criteria; and
cause a velocity profile stop for an elevator car via operation of a motor drive unit of the elevator system, if the received status information fulfills a second emergency stopping criteria.

2. The elevator safety controller of claim 1, configured to cause the velocity profile stop as a default emergency stop.

3. The elevator safety controller of claim 1, configured to cause the immediate stop after initiating the velocity profile stop if, after the initiating, the first emergency stopping criteria is fulfilled.

4. The elevator safety controller of claim 1, wherein the velocity profile stop is a constant deceleration stop or a constant braking torque stop.

5. The elevator safety controller of claim 1, wherein the immediate stop is a maximum deceleration stop, such as by the elevator brake.

6. The elevator safety controller of claim 1, wherein said first emergency stopping criteria comprises at least one of: the stop to be caused is a consequence of a time-critical failure, and the stop to be caused is a consequence of a mechanically blocked failure.

7. The elevator safety controller of claim 6, wherein the time-critical failure relates to one of the following: unintended car movement protection situation, emergency terminal speed limiting situation, an overspeed situation of an ascending elevator car.

8. The elevator safety controller of claim 6, wherein the mechanically blocked failure is or relates to a buffer run, a stalling situation of elevator car, or operation of a safety gear.

9. The elevator safety controller of claim 1, wherein the second emergency stopping criteria comprises: the stop to be caused is a consequence of a single-channel failure of at least one of the elevator components or a consequence of a person operating an inspection operating button or buttons, an emergency electrical operation button or buttons, or stopping device or devices.

10. The elevator safety controller of claim 1, wherein the safety controller is arranged to receive status information from a motor drive unit of the elevator system about determination/identification of the mechanically blocked failure based on a criteria related to predetermined change in torque requirement of a hoisting motor of the elevator system.

11. The safety controller of claim 1, wherein the first emergency stopping criteria has a higher priority than the second emergency stopping criteria, such that upon causing the immediate stop it will remain valid until an elevator car has stopped, and it can only be reset after stopping of the elevator car.

12. The elevator safety controller of claim 1, wherein the second emergency stopping criteria comprises: the stop to be caused is a consequence of an overspeed situation of an elevator car located in a middle of an elevator shaft of the elevator system.

13. The elevator safety controller of claim 1, wherein the second emergency stopping criteria comprises: the stop to be caused is a consequence of a landing door contact opening at a long distance away from the elevator car.

14. The elevator safety controller of claim 13, wherein the long distance is such that the elevator car is estimated to be stopped before reaching the landing with the landing door contact opening.

15. The elevator safety controller of claim 1, configured to cause the velocity profile stop to move the elevator car to a landing floor.

16. The elevator safety controller of claim 1, configured to cause an immediate stop via operation of the elevator brake, if the received status information fulfills an overspeed situation during the velocity profile stop.

17. An elevator system, comprising:
an elevator car for transferring users and/or cargo between landing floors;
a hoisting motor configured to move the elevator car;
a motor drive unit configured to drive the hoisting motor;
an elevator brake;
a plurality of elevator components; and
an elevator safety controller in accordance with claim 1.

18. The elevator system of claim 17, comprising diagnostic means for diagnosing operating condition of landing door system.

19. The elevator system of claim 17, wherein at least one of the elevator components has a functionally duplicated two-channel structure.

20. The elevator system of claim 17, wherein the plurality of elevator components comprises at least one of or are selected from the group consisting of: an elevator safety device, such as a camera, a position sensor, a landing door contact, a car door contact, or a final limit switch.

21. The elevator system of claim 17, wherein the elevator component is an elevator control unit or a component of a control unit, such as a processor.

22. The elevator system of claim 17, wherein the elevator safety controller is at least communicatively connected to the plurality of elevator components.

23. The elevator system of claim 17, wherein the safety controller is arranged for receiving status information from the motor drive unit, and wherein the motor drive unit is configured to determine/identify the mechanically blocked failure based on a criteria related to predetermined change in torque requirement of the hoisting motor.

24. A method for causing an emergency stop for an elevator car, the method comprising:
receiving, an elevator safety controller, status information from a plurality of elevator components of an elevator system,
selectively causing an immediate stop or a velocity profile stop for an elevator car, wherein
the immediate stop is performed via operation of an elevator brake of the elevator system, if the received status information fulfills a first emergency stopping criteria, and
the velocity profile stop is performed via operation of a motor drive unit of the elevator system, if the received status information fulfills a second emergency stopping criteria.
